(19) United States
(12) Patent Application Publication
(10) Pub. No.: US 2007/0137769 A1
(43) Pub. Date: Jun. 21, 2007

(54) Method for forming a printed film-nonwoven laminate

(76) Inventors: Patrick L. Payne, Lithonia, GA (US); John Herbert Conrad, Alpharetta, GA (US); Michael T. Houston, Cumming, GA (US); Ali Yahiaoui, Roswell, GA (US)

Correspondence Address: Pauley Petersen & Erickson;Suite 365, 2800 West Higgins Road, Hoffman Estates, IL, 60195, US

(21) Appl. No.: 11/304,056

(22) Filed: Dec. 15, 2005

(51) Int. Cl. B32B 37/00

(52) U.S. Cl. 156/167; 156/277

(57) ABSTRACT

An integrated method of making a printed film-nonwoven laminate, wherein the layers of the laminate are formed, printed and laminated within the same process. The method includes forming a nonwoven web, corona treating the nonwoven web, applying a print to a surface of the nonwoven web and immediately feeding the nonwoven web into a laminator where film is combined with or laminated to the nonwoven web. The film may also be formed and/or printed during the process prior to being fed into the laminator. The invention further includes apparatus for carrying out the integrated method.

### BACKGROUND OF THE INVENTION

The invention is directed to an integrated method for forming a printed film-nonwoven laminate.

Conventional methods of manufacturing printed film-nonwoven web laminates include a multi-step process with a first step of making a spunbond web or other nonwoven web on a spunbond baseline or other nonwoven line and winding the nonwoven onto a roll. The second step is carried out after the nonwoven web is delivered to the lamination site, at which point the nonwoven web is unwound and laminated to a film on a laminate line. Thereafter, the film-nonwoven laminate is transferred to a printing station where a graphic is applied to a surface of the nonwoven web. Prior to printing, either the nonwoven web or the film-nonwoven laminate may be corona treated to improve adhesion of the printed graphic.

Significant capital and material costs are expended in building and maintaining separate facilities for the nonwoven web production, film production, laminate production lines and printing stations, in addition to the costs of storing the nonwoven webs and transporting the nonwoven webs to the lamination facilities. Furthermore, transporting the nonwoven webs to the lamination facilities and setting up the nonwoven webs on the production line consumes a considerable amount of time and exposes the material to multiple handlings which can damage the material and increase yield loss.

Operation of conventional printing stations is both speed and width limited. Thus, the film-nonwoven laminate is split or slit into several sections to provide a cross-directional width suitable for processing in the printing station. Additionally, printing line speeds are typically slower than laminate production speeds which results in reduced finished product throughput.

Besides cost savings and efficiency, another area of current printed film-nonwoven laminate production that has room for improvement is the finished product. It has been discovered that the printability of nonwoven webs, spunbond webs in particular, improves with the application of a corona treatment. However, from the time the nonwoven webs are manufactured, corona treated and delivered to a printing station at least some decay in the surface energy imparted by the corona treatment has already occurred due to surface pollution. Thus, nonwoven webs previously manufactured and corona treated may need to be “refreshed” with an additional application of corona treatment to ensure adhesion of the printing inks to the surface of the nonwoven web and produce quality graphic prints.

There is a need or desire for a method of forming printed film-nonwoven laminates with reduced costs and increased efficiency, resulting in laminates having improved graphic quality.

There is a further need or desire for apparatus for forming printed film-nonwoven laminates at a reduced cost and with increased efficiency, resulting in laminates having improved graphic quality.

### SUMMARY OF THE INVENTION

In response to the discussed difficulties and problems encountered in the prior art, an integrated method of manufacturing printed film-nonwoven laminates, and apparatus for carrying out the method, have been discovered.

The method of the invention is an integrated method including the steps of forming a nonwoven web from a plurality of extruded thermoplastic polymer fibers, corona treating the nonwoven web before the thermoplastic polymer reaches 75% of a final percent crystallization, applying a print to a surface of the nonwoven web before the thermoplastic polymer reaches 75% of the final percent crystallization, and combining the nonwoven web with a film. The surface modification effects of corona treatment can also be achieved with other methods such as atmospheric plasma or flame treatments. The nonwoven web may be combined with or laminated to the film before a print is applied to a surface of the film-nonwoven laminate.

The method of the invention may further include corona treating and/or printing the nonwoven web before the thermoplastic polymer reaches 50% of a final percent crystallization. The print may be applied to a surface of the nonwoven web, and additionally to a surface of the film, using any one of a digital printing process, a flexographic printing process or a combined flexographic-digital printing process. The print may be applied to a surface of the nonwoven web in a two-step process including applying a base print and applying at least one detail print over the base print. Additionally, the film may be formed simultaneously with the nonwoven web and may be stretched to render the film breathable. The printed film-nonwoven laminate may be formed at a line speed of about 500 fpm (about 152 m/min) to about 2000 fpm (about 610 m/min).

An apparatus for forming the printed film nonwoven laminate suitably includes a laminator, a nonwoven forming device for feeding a nonwoven web into the laminator, a corona treatment device for treating the nonwoven web, a device for applying a print on a surface of the nonwoven web and a device for feeding a film into the laminator. In another embodiment, the apparatus may further include a device for applying a print to a surface of the film. In yet another embodiment, the apparatus is used to simultaneously form a film, and the apparatus suitably includes a film die that feeds a film into the laminator.

With the foregoing in mind, particular embodiments of the invention provide a method and apparatus for efficiently forming a printed film-nonwoven laminate.

### BRIEF DESCRIPTION OF THE DRAWINGS

FIG. 1 is an illustration of an exemplary process for forming a printed film-nonwoven laminate according to one embodiment of the invention.

FIG. 2 is an illustration of an exemplary digital printing process for forming a printed film-nonwoven laminate.

FIG. 3 is an illustration of a process for forming a printed film-nonwoven laminate using a combined flexographic-digital printing process.

FIG. 4 is an illustration of an exemplary process for forming a printed film-nonwoven laminate according to another embodiment of the invention.

FIG. 5 is an illustration of an exemplary process for forming a printed film-nonwoven laminate according to a further embodiment of the invention.

FIG. 6 is an illustration of an exemplary process form forming a printed film-nonwoven laminate according to yet another embodiment of the invention.

### DEFINITIONS

Within the context of this specification, each term or phrase below will include the following meaning or meanings.

“Integrated method” refers to a one location method wherein all individual operations or method steps are conducted continuously on a single production line including two or more processing stations or modules.

“Laminate” refers to a composite material including two or more coterminous layers, webs or sheets of material which are combined, joined, bonded or laminated together.

“Nonwoven” or “nonwoven web” refers to materials and webs of material having a structure of individual fibers or filaments which are interlaid, but not in an identifiable manner as in a knitted fabric. The terms “fiber” and “filament” are used interchangeably. Nonwoven fabrics or webs have been formed from many processes such as, for example, meltblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns or denier. (Note that to convert from osy to gsm, multiply osy by 33.91.)

“Spunbond fiber” refers to small diameter fibers which are formed by extruding molten thermoplastic material as filaments from a plurality of fine capillaries of a spinnerette having a circular or other configuration, with the diameter of the extruded filaments then being rapidly reduced as by, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartmann, U.S. Pat. No. 3,502,538 to Petersen, and U.S. Pat. No. 3,542,615 to Dobo et al., each of which is incorporated herein in its entirety by reference. Spunbond fibers are quenched and generally not tacky when they are deposited onto a collecting surface. Spunbond fibers are generally continuous and often have average deniers larger than about 0.3, more particularly, between about 0.6 and 10.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

“Polymers” and “thermoplastic polymer” include, but are not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the material. These configurations include, but are not limited to isotactic, syndiotactic and atactic symmetries.

“Corona treatment” and “corona discharging treatment” refers to a process to increase the surface energy of a plastic or thermoplastic polymer substrate wherein active species (e.g., electrons, ions, radicals, metastables, etc.) are formed in a gap between two electrodes which are energized to form a dielectic discharge. These active species impinge on the surface of the polymeric substrate which passes in the gap between the electrodes causing the polymer molecular chains on the surface of the substrate to undergo interactions with the active species and produce a plurality of polar functional groups on the surface of the substrate. The polar functional groups encompass carbonyl, hydroxyl and other functional groups depending on the chemistries present in the gap between the corona electrodes. If desired, broader types of functional groups can be achieved using atmospheric plasma treatments. Corona or atmospheric plasma treatments typically result in surface oxidation, increased surface energy and increased adhesion of printing inks.

“Fresh” or “green” nonwoven webs or films refer to nonwoven webs or films which, immediately after formation by extrusion from a spinnerette or other die, have not yet reached 75%, or not yet reached 50% of a final percent crystallization of the polymer(s) forming the nonwoven web or film. For example, a polypropylene spunbond web having 80% final crystallization (i.e. a final crystallization equal to 80% of a theoretical total crystallization) may be considered green or fresh immediately after formation, before it reaches 60% crystallization or before it reaches 40% crystallization. When a polymer blend is used to form the web or film, the web or film is considered “green” before the polymers in the blend collectively reach 75% of a final percent crystallization or before they collectively reach 50% of a final percent crystallization. The degree of crystallization of a film, web or other polymer material may be determined using the standard test method defined in ASTM D3418-03.(Differential scanning calorimetry).

“Film” refers to a thermoplastic film made using a film extrusion and/or forming process, such as a cast film or blown film extrusion process. The term includes apertured films, slit films, and other porous films which constitute liquid transfer films, as well as films which do not transfer liquid.

“Flexographic printing” or “flexography” refers to a method of direct rotary printing utilizing resilient relief image plates made of rubber or a photopolymer material. The plates are secured to one or more cylinders and ink is applied to the plates by a cell structured, ink-metering roll such as an “anilox” roll which delivers a liquid ink to a surface of the relief image plates. Suitably, the liquid ink is fast-drying and capable of printing onto nearly any substrate, particularly, polymeric substrates. Each revolution of the relief image plate bearing cylinder applies a print or image to an associated substrate.

“Digital printing” or “continuous ink jet printing” refers to a method of creating variable imaging using the concept of electrostatically charging singularly, continuously generated drops of ink.

“Elastomeric” or “elastic” refers to a material or composite which can be elongated by at least 50 percent of its relaxed length and which will recover, upon release of the applied force, at least 50 percent of its elongation. It is generally preferred that the elastomeric material or composite be capable of being elongated by at least 100 percent, more preferably by at least 300 percent, of its relaxed length and recover, upon release of an applied force, at least 75 percent of its elongation. For example, a 1-inch sample stretched 100% to 2 inches and returning to 1.5 inches upon release of the applied force recovers 50% of its elongation.

As used herein, the term “machine direction” or MD means the length of a fabric in the direction in which it is produced. The term “cross machine direction”, “cross direction” or CD means the width of fabric, i.e. a direction generally perpendicular to the MD.

“Breathable film” or “breathable laminate” refers to a film or laminate having a water vapor transmission rate (“WVTR”) of at least about 500 grams/m²/24 hours, determined using ASTM Standard Test Method for Water Vapor Transmission of Materials, Designation E-96-80.

### DETAILED DESCRIPTION OF THE INVENTION

The present invention is directed to an integrated method of efficiently forming printed film-nonwoven laminates. In this single-location method, a fresh or green nonwoven web is formed and fed into a laminator where the nonwoven web is combined with a film which may either be pre-formed or may also be formed within the same process. The fresh nonwoven web may be corona treated and printed prior to being fed into the laminator. Alternatively, a film-nonwoven laminate may be corona treated and printed after lamination but while the nonwoven web and/or the film is still fresh or green.

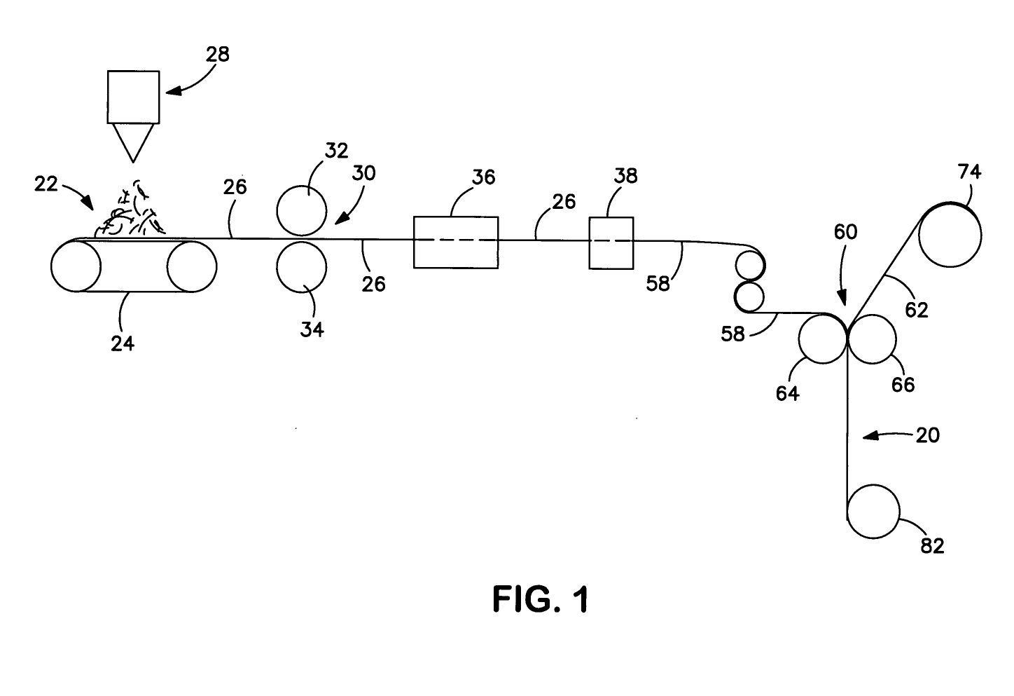

Referring to FIG. 1, there is shown an embodiment of the method of producing a printed film-nonwoven laminate 20. More specifically, as shown, thermoplastic polymer fibers 22 are substantially randomly deposited onto a forming belt 24 to form a nonwoven web 26, in a manner conventionally used to form nonwoven webs as known to those skilled in the art. The fibers 22 may be deposited, for example, on the forming belt using a spinnerette 28. The nonwoven web 26 may be made of fiber-forming thermoplastic polymers such as, for example, polyolefins. Exemplary polyolefins include one or more of polypropylene, polyethylene, ethylene copolymers, propylene copolymers, and butene copolymers. The fibers 22 may be meltblown fibers, spunbond fibers, bi-component fibers, sheath-core fibers, side-by-side fibers, or any other suitable type of fibers.

As the fibers 22 are deposited on the forming belt 24, a vacuum unit may be positioned under the forming belt to draw the fibers towards the forming belt during the formation of the nonwoven web 26. The fibers can be joined by interfiber bonding to form a coherent web structure. Suitable nonwoven webs 26 formed on the forming belt 24 include without limitation spunbond webs, such as polypropylene spunbond webs, and meltblown webs. Suitably, the nonwoven web 26 may have a width of up to about 130 inches (about 330 cm).

As the nonwoven web 26 is formed, the web is passed through a bonding device, such as a calender 30, including a calender roller 32 and an anvil roller 34, to bond the fibers 22 for further formation of the web. While the anvil roller 34 is suitably smooth, the calender roller 32 may be smooth but is preferably patterned to add a bond pattern to the web. Examples of suitable bond patterns include pin embossing or a sinusoidal bonding pattern. One or both of the calender roller 32 and the anvil roller 34 may be heated and the pressure between these two rollers may be adjusted by well-known means to provide the desired temperature, if any, and bonding pressure to form the nonwoven web 26. The calender 30 can also function as a nip for necking the web. Generally speaking, a nip is an area located between two rolls in close proximity.

After passing through the calender 30, the nonwoven web passes through a corona treatment station 36. Suitably, the corona treatment is applied to the nonwoven web 26 before the thermoplastic polymer fibers 22 reach 75% of a final percent crystallization. Suitably, the corona treatment is applied to the nonwoven web 26 before the thermoplastic polymer fibers 22 reach 50% of a final percent crystallization. For example, polypropylene has a crystallization half-life at 27 degrees Celsius of about 12 seconds. Therefore, after about 24 seconds at 27 degrees Celsius, polypropylene reaches 75% of final crystallization. A more detailed explanation of the crystallization kinetics of polypropylene is provided in the article “Interpretation of the Nonisothermal Crystallization Kinetics of Polypropylene Using a Power Law Nucleation Rate Function,” by Zhuomin Ding and Joseph E. Spruiell, published in J. Poly. Sci. B Polym. Phys., 35, 1077 (1997).

If expressed in another way, the nonwoven web 26 passes through the corona treatment station 36 within about 24 seconds after leaving the calender 30, or within about 12 seconds, or within about 1 to 2 seconds or less than one second. Suitably, the corona treating is performed immediately after the nonwoven web 26 leaves the calender 30.

Thermoplastic polymer materials used to form the nonwoven and film layers of the printed film-nonwoven laminate 26 may have surface energy levels at or below the surface energy of the inks used during printing which may result in poor ink adhesion and graphic development. For example, polyolefins exhibit a surface energy of about 29-31 mN/m (dyne/cm) whereas many water-based inks require a surface energy of about 45 mN/m (dyne/cm) to adhere to a printed surface and many solvent-based inks require a surface energy of about 40 mN/m (dynes/cm). To improve adhesion of the inks during the printing process, a surface of a thermoplastic polymer substrate such as a web or film is corona treated to remove absorbed contaminant materials that normally form a weak boundary which hinders ink adhesion. Corona treatment also modifies the substrate surface in order to increase the surface energy, improve the substrate wettability and improve the ability of the substrate surface to strongly interact with an applied ink through polar or hydrogen bonding and/or electrostatic forces. Corona treatment can be applied to the substrate surface without significant modification of mechanical, optical, or electrical propertied of even very thin films. The surface tension of the inks and the surface energy of the thermoplastic substrate before and after corona treatment may be determined using the standard test method defined in ASTM D 2578-84. The terms “surface tension” and “surface energy” may be used interchangeably. However, it is customary to us the term “surface tension” when referring to liquids and the term “surface energy” when referring to solid surfaces.

Corona dosage may vary depending upon the line speed, electric power of the corona treatment unit, and width of the treatment area. Suitably, the corona treatment station 36 extends in the cross machine direction or CD across the full width of the nonwoven web 26. Suitably, the corona treatment station 36 may extend beyond the margins of the nonwoven web 26 in the cross machine direction. Results of the corona treatment are determined by the intensity of the treatment. Treatment intensity or corona dosage may be determined using the following equation:

$$D = \frac{P}{ES} \times v$$

where:
D=dosage [Wmin/m²]
P=electric power of the corona [W]
ES=width of the corona station [m]
v=line speed [m/min]
   For example, the corona dosage applied to a polypropylene substrate must exceed about 20 Wmin/m² or about 100 Wmin/m² or about 200 Wmin/m² to sufficiently increase the surface energy and ensure adhesion of the ink to the substrate surface. Depending upon the substrate, higher energy corona treatments, such as levels greater than about 500 Wmin/m², may also be applied. Alternatively, multiple corona treatment units may be positioned within the corona treatment station 36. Each corona treatment unit may provide a lower individual dose of corona treatment while providing a cumulative corona dosage which exceeds about 20 Wmin/m² or about 100 Wmin/m² or about 200 Wmin/m². The use of multiple corona treatment units within the corona treatment station 36 may alleviate pinhole formation in the substrate which is often associated with relatively high energy corona treatment of polymeric materials.

A corona treatment unit suitable for use in forming a printed film-nonwoven laminate is available, for example, from TIGRES Dr. Gerstenberg GmbH, Rellingen Germany through PLASMAtech, inc., Erlanger, Kentucky or Enercon Industries Corporation, Menomonee Falls, Wis.

After passing through the corona treatment station 36, the nonwoven web 26 is fed into a printing station 38 wherein a print is applied to a surface of the nonwoven web 26. Suitably, the print is applied to a surface of the nonwoven web 26 before the thermoplastic polymer fibers 22 reach 75% of a final percent crystallization. Suitably, the print is applied to a surface of the nonwoven web 26 before the thermoplastic polymer fibers 22 reach 50% of a final percent crystallization. Suitably, the print is applied to the surface of the nonwoven web 26 immediately after the nonwoven web 26 leaves the corona treatment station 36.

If expressed in another way, the nonwoven web 26 passes through the printing station 38 within about 24 seconds after leaving the calender 30, or within about 12 seconds, or within about 3 seconds, or within about 1 second.

As the green nonwoven web proceeds through the production process it is exposed to environmental pollutants such as dust and oils which may reduce the surface energy of the web thereby decreasing the wettability of the web and further inhibiting adhesion of the printing inks to the web surface. By corona treating and printing the nonwoven web while it is still fresh or green, better adhesion of the inks may be achieved and the graphic quality of the finish product may be improved. Additionally, reducing the time between corona treatment and printing reduces the amount of surface energy decay and lessens the need to refresh the nonwoven web or reapply the corona treatment prior to printing thereby improving print quality and production efficiency.

The print may be applied to the surface of the nonwoven web 26 using a flexographic printing process, a digital printing process or a combination flexographic-digital printing process. In one embodiment, the printing station 38 may include a flexographic printer which extends in the cross machine direction across substantially the full width of the nonwoven web 26. The flexographic printing press may be designed in one of the following configurations: central impression (CI) drum, stack or in-line. Typically, in high speed industrial printing processes, CI drum presses may be utilized. This design provides an improved capability to obtain precise and desired graphic registration. A CI drum press may be equipped with 1 to 10 printing station. Each printing station includes an anilox roll, a plate cylinder and an impression cylinder. The anilox roll transfers a desired amount of ink onto a printing plate mounted on the plate cylinder. The printing plate on the printing cylinder and the impression cylinder define a nip where an ink print, graphic or image is transferred from the plate onto a surface of a substrate passing through the nip. After the print is applied to a surface of the substrate, the substrate may be passed through a drying section either prior to lamination or after lamination and before being wound.

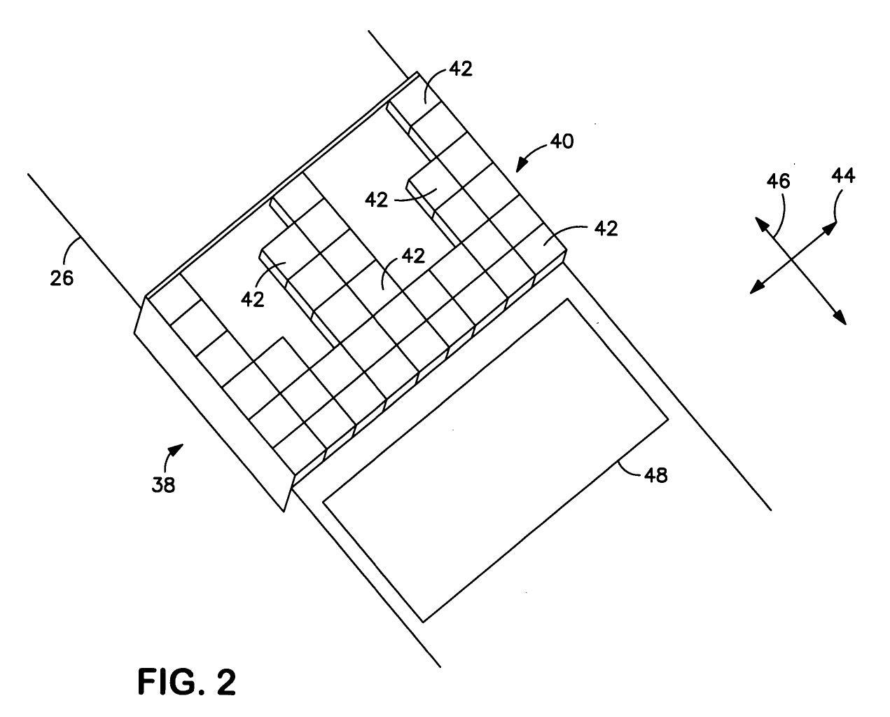

In another embodiment, printing station 38 may include a digital printer which extends in the cross machine direction across substantially the full width of the nonwoven web 26. Referring the FIG. 2, printing station 38 includes a digital printer 40. The digital printer 40 includes a plurality of non-contact continuous ink jet print heads 42 extending in the cross machine direction 44 across the width of nonwoven web 26. Suitably, continuous ink jet print heads 42 may be also be arranged in columns in the machine direction 46. Each continuous ink jet print head 42 may be supplied with ink via an attached tube or umbilical cord (not shown) which delivers ink pumped from an ink supply station (not shown). Suitable ink colors include cyan, yellow, magenta, black, orange and green. Print registration may be achieved by electromechanical actuation of the print heads 42 in the cross machine direction 44. As nonwoven web 26 passes through the printing station 38 a print 48 is applied to a surface of the nonwoven web. While the digital printer 40 illustrated in FIG. 2 depicts one arrangement of continuous ink jet print heads, other arrangements may be utilized to achieve the desired print result.

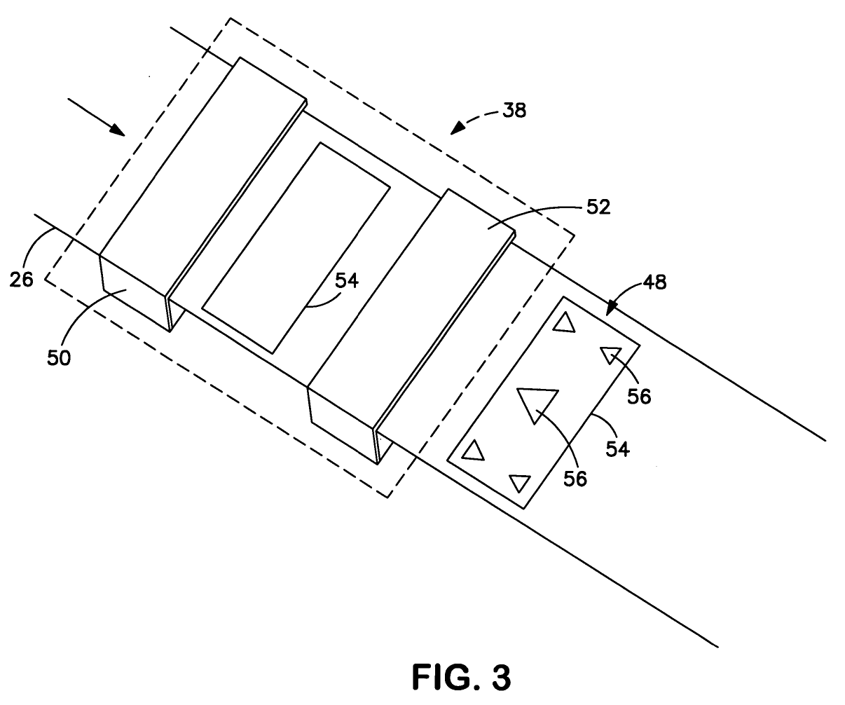

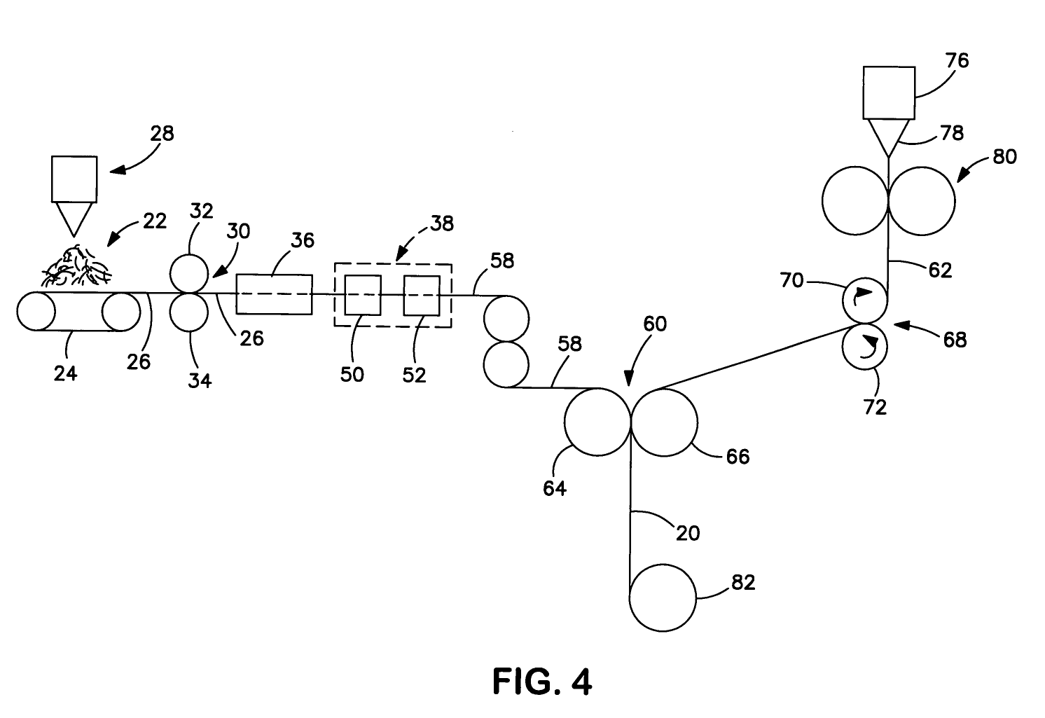

In another embodiment, printing station may include one or more printers. Referring to FIGS. 3 and 4, printing station 38 includes a first printer 50 and a second printer 52. The first printer 50 may be a flexographic printer or a digital printer. The second printer 52 may also be a flexographic printer or a digital printer. Suitably, first printer 50 and second printer 52 may be the same type of printer or they may be different types of printer. First printer 50 may apply a base print 54 on a surface of nonwoven web 26. Suitably, second printer 52 may apply at least one detail print 56 over base print 54 to form a complete print 48 on a surface of nonwoven web 26. In one embodiment, first printer 50 may be a flexographic printer which applies a base print 54 on a surface of nonwoven web 26 and the second printer 52 may be a digital printer which applies at least one detail print 56 over the base print 54 to form a complete print 48 on a surface of the nonwoven web 26.

Referring again to FIG. 1, the printed nonwoven web 58 is transported into the nip of a laminator including a pressure roll arrangement 60 where the printed nonwoven web 58 is combined with a film 62 to form a printed film nonwoven laminate 20. Suitably, the printed nonwoven web 60 is laminated to the film by passing the two webs between a first pressure roll 64 and a second pressure roll 66 which can be set to define a controlled gap between the rolls. For example, the gap setting between the pressure rollers 64, 66 may be at about 15 mils to about 100 mils, or at about 20 mils to about 50 mils, or at about 25 mils to about 30 mils. Suitably, the film 62 is combined with or laminated to the printed nonwoven web 58 before the thermoplastic polymer fibers 22 reach 75% of a final percent crystallization. Suitably, the film 62 is combined with or laminated to the printed nonwoven web 58 before the thermoplastic polymer fibers 22 reach 50% of a final percent crystallization.

Suitably, the film 62 and the printed nonwoven web 58 are combined or laminated together while one or both materials are still in a green or fresh state. As the thermoplastic polymer(s) age and crystallize, the polymer fibers or film harden and become more brittle. During subsequent processing, the nonwoven webs or films may be subjected to stretching or other mechanical stresses. Nonwoven webs or films which include polymer(s) having a level of crystallinity that exceeds 75% of a final percent crystallization or exceeds 50% of a final percent crystallization may develop surface damage or abrasion due to the loss of flexibility which may result in reduced graphic quality in the final printed film-nonwoven laminate product.

The nonwoven web 26 and the film 62 may desirably be formed from or made using thermoplastic polymers, and/or may desirably be formed from or made using elastic polymers and/or elastic thermoplastic polymers.

Polymers suitable for making polymeric films and fibrous or webs include those polymers known to be generally suitable for making films and nonwoven webs such as spunbond, meltblown, carded webs and the like, and such polymers include for example polyolefins, polyesters, polyamides, polycarbonates and copolymers and blends thereof. It should be noted that the polymer or polymers may desirably contain other additives such as processing aids or treatment compositions to impart desired properties to the fibers, residual amounts of solvents, pigments or colorants and the like.

Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(I-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include poly(lactide) and poly(lactic acid) polymers as well as polyethylene terephthalate, polybutylene terephthalate, polytetramethylene terephthalate, polycyclohexylene-1,4-dimethylene terephthalate, and isophthalate copolymers thereof, as well as blends thereof.

Many elastomeric polymers are known to be suitable for forming extensible materials that are also elastic, i.e., materials that exhibit properties of stretch and recovery, such as elastic fibers and elastic fibrous web layers, and elastic film materials. Thermoplastic polymer compositions may desirably comprise any elastic polymer or polymers known to be suitable elastomeric fiber or film forming resins including, for example, elastic polyesters, elastic polyurethanes, elastic polyamides, elastic co-polymers of ethylene and at least one vinyl monomer, block copolymers, and elastic polyolefins. Examples of elastic block copolymers include those having the general formula A-B-A′ or A-B, where A and A′ are each a thermoplastic polymer endblock that contains a styrenic moiety such as a poly (vinyl arene) and where B is an elastomeric polymer midblock such as a conjugated diene or a lower alkene polymer such as for example polystyrene-poly(ethylene-butylene)-polystyrene block copolymers. Also included are polymers composed of an A-B-A-B tetrablock copolymer, as discussed in U.S. Pat. No. 5,332,613 to Taylor et al. An example of such a tetrablock copolymer is a styrene-poly(ethylene-propylene)-styrene-poly(ethylene-propylene) or SEPSEP block copolymer. These A-B-A′ and A-B-A-B copolymers are available in several different formulations from Kraton Polymers U.S., L.L.C. of Houston, Tex. under the trade designation KRATON®. Other commercially available block copolymers include the SEPS or styrene-poly(ethylene-propylene)-styrene elastic copolymer available from Kuraray Company, Ltd. of Okayama, Japan, under the trade name SEPTON®.

Other exemplary materials which may be used include polyurethane elastomeric materials such as, for example, those available under the registered trademark ESTANE from Noveon, Inc. of Cleveland, Ohio, polyamide elastomeric materials such as, for example, those available under the registered trademark PEBAX from ATOFINA Chemical Company of Philadelphia, Pa., and polyester elastomeric materials such as, for example, those available under the registered trademark HYTREL from E.I. duPont De Nemours & Company of Wilmington, Del. Formation of elastic sheets from polyester elastic materials is disclosed in, for example, U.S. Pat. No. 4,741,949 to Morman et al., hereby incorporated by reference.

Examples of elastic polyolefins include ultra-low density elastic polypropylenes and polyethylenes, such as those produced by “single-site” or “metallocene” catalysis methods. Such polymers are commercially available from the DuPont Dow Elastomers, L.L.C. of Wilmington, Del. under the trade name ENGAGE®, and described in U.S. Pat. Nos. 5,278,272 and 5,272,236 to Lai et al. entitled “Elastic Substantially Linear Olefin Polymers”. Also useful are certain elastomeric polypropylenes such as are described, for example, in U.S. Pat. No. 5,539,056 to Yang et al. and U.S. Pat. No. 5,596,052 to Resconi et al., incorporated herein by reference in their entireties, and polyethylenes such as AFFINITY® EG 8200 from Dow Chemical of Midland, Mich. as well as EXACT® 4049, 4011 and 4041 from the ExxonMobil Chemical Company of Houston, Tex., as well as blends. Still other elastomeric polymers are available, such as the elastic polyolefin resins available under the trade name VISTAMAXX from the ExxonMobil Chemical Company, Houston, Tex., and the polyolefin (propylene-ethylene copolymer) elastic resins available under the trade name VERSIFY from Dow Chemical, Midlands, Mich.

A polyolefin may be used alone to form an extensible film or nonwoven material or may be blended with an elastomeric polymer to improve the processability of the composition. The polyolefin may be one which, when subjected to an appropriate combination of elevated temperature and elevated pressure conditions, is extrudable, alone or in blended form. Useful polyolefin materials include, for example, polyethylene, polypropylene and polybutene, including ethylene copolymers, propylene copolymers and butene copolymers. Two or more of the polyolefins may be utilized. Extrudable blends of elastomeric polymers and polyolefins are disclosed in, for example, U.S. Pat. No. 4,663,220 to Wisneski et al., hereby incorporated by reference.

The film 62 may include a filled film. The filled film may be formed by blending one or more polyolefins and/or elastomeric resins with a particulate filler. The filler particles may include any suitable organic or inorganic material. Generally, the filler particles should have a mean particle diameter of about 0.1 to about 8.0 microns, desirably about 0.5 to about 5.0 microns, and more desirably about 0.8 to about 2.0 microns. Suitable inorganic filler particles include without limitation calcium carbonate, non-swellable clays, silica, alumina, barium sulfate, sodium carbonate, talc, magnesium sulfate, titanium dioxide, zeolites, aluminum sulfate, diatomaceous earth, magnesium carbonate, barium carbonate, kaolin, mica, carbon, calcium oxide, magnesium oxide, aluminum hydroxide. Suitable organic filler particles include polymer particles or beads. Calcium carbonate is the presently desired filler particle.

In one embodiment, the film 62 may be stretch-thinned to cause void formation around the filler particles thereby making the film breathable. For example, referring to FIG. 4, the film 62 may be passed through a 68 between a first roller 70 and a second roller 72 and transported to the nip of the pressure roll arrangement 60 between first and second pressure roll 64, 66. By adjusting the difference in the speeds of first and second rollers 70, 72 and first and second pressure rolls 64, 66, the film 62 is tensioned so that it stretches a desired amount and thereby forms a breathable film.

The film 62 can be either a pre-formed film, fed from a storage roll 74 into the nip of pressure roll arrangement 60, as shown in FIG. 1, or can be formed on-site, simultaneously with or while the nonwoven web 26 is being formed, and extruded into the nip of pressure roll arrangement 60, as shown in FIG. 4. FIG. 4 is essentially the same as FIG. 1 with the exception of the film 62 being formed on-site and fed from an extruder 76 through a film die 78 into a chill roll arrangement 80.

Referring again to FIG. 1, at the pressure roll arrangement 60, pressure is applied to combine, bond or laminate the printed nonwoven web 58 to a rolled out or extruded film 62 thereby forming a printed film-nonwoven laminate 20 which can be wound up on a wind-up roll 82. Conventional bonding techniques, such as thermal bonding, ultrasonic bonding, and/or adhesive bonding, with either total bonding as occurs during extrusion coating or point-bonding possible, can be used to bond the film 62 to the printed nonwoven web 58. Referring to FIG. 4, desirably, one or both of the pressure rolls 64, 66 may be chilled. For example, one or both of the pressure rolls may be chilled to temperatures of 55 to 50 degrees Fahrenheit or less. Chilling the pressure rolls is believed to help cool the extruded polymer film 62 so it more rapidly “sets” in bonding contact with the printed nonwoven web 58.

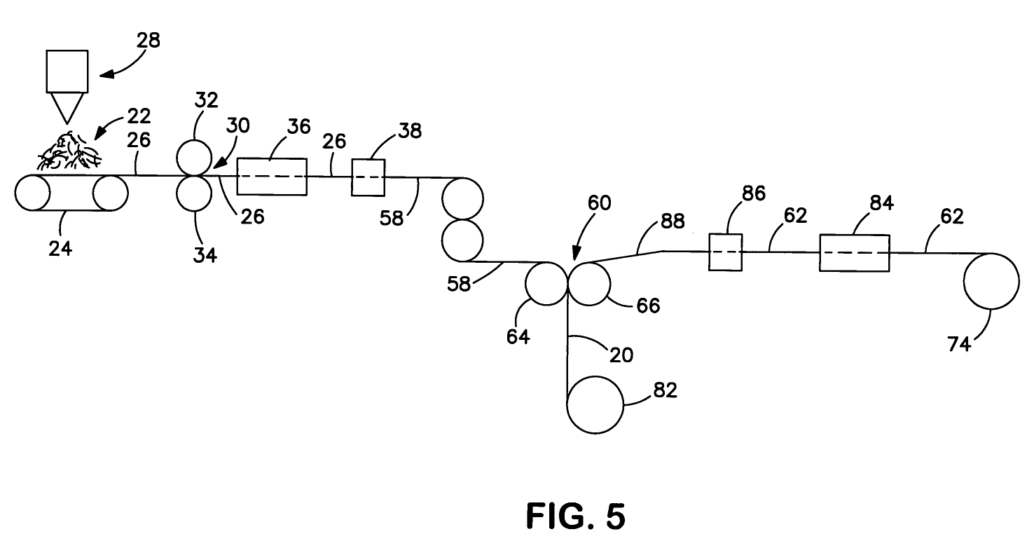

In another embodiment, the film 62 may also be printed prior to combining or laminating the film to a printed nonwoven web 58. Referring to FIG. 5, a film 62 may be unwound from a supply roll 74 and passed through a corona treatment station 84. The treated film may then be passed through a printing station 86 to apply a print to a surface of the film 62. Suitably, the print may be applied to a surface of the film 62 using a flexographic printing process, a digital printing process or a combined flexographic-digital printing process. The printed film 88 is then transported to the pressure roll arrangement 60 where the printed film is combined with or laminated to the printed nonwoven web 58 to form a printed film-nonwoven web laminate 20.

When the film 62 is formed in-line, it may be corona treated in a green state, before the film-forming polymer(s) collectively reach 75% of a final percent crystallization or before they reach 50% of a final percent crystallization. The film 62 may also be printed before the film-forming polymer(s) collectively reach 75% of a final percent crystallization or before they reach 50% of a final percent crystallization.

Suitably, the film 62 is corona treated and printed while in a fresh or green state to reduce contact with surface pollutants and improve adhesion of the printing inks to the surface of film to provide enhanced graphic quality in the finished printed film-nonwoven laminate 20.

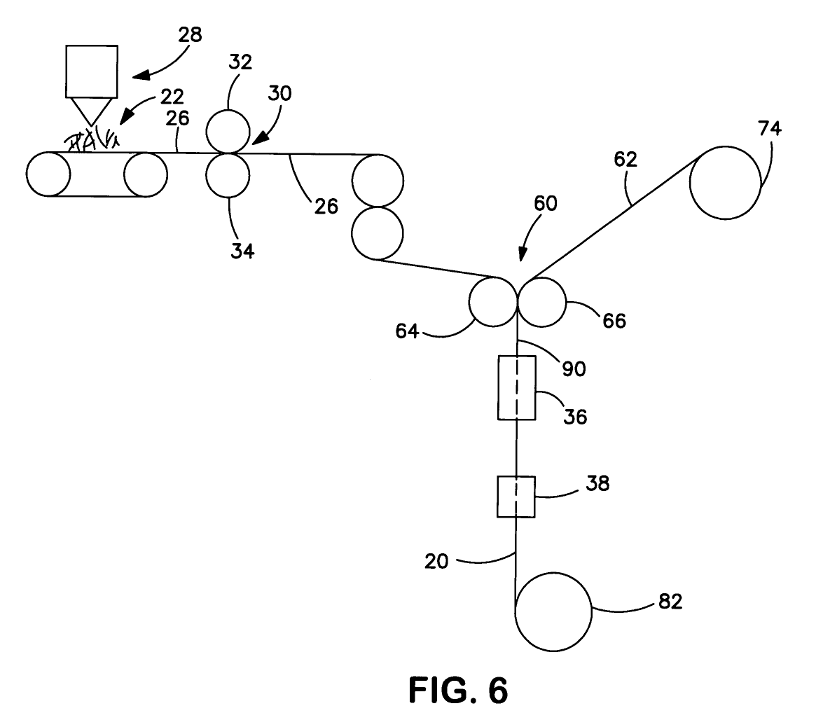

In a further embodiment, a print may be applied to a surface of the nonwoven web 26 after a film-nonwoven laminate is formed. Referring to FIG. 6, a nonwoven web 26, produced as described above, and a film 62 are passed through pressure roll arrangement 60 to combine, bond or laminate the nonwoven web 26 to the film 62 to form a film-nonwoven laminate 90. Suitably, the nonwoven web 26 is combined with or laminated to the film 62 before the thermoplastic polymer fibers 22 reach 75% of a final percent crystallization. Suitably, the nonwoven web 26 is combined with or laminated to the film 62 before the thermoplastic polymer fibers 22 reach 50% of a final percent crystallization.

If expressed in another way, the nonwoven web 26 is combined with or laminated to the film 62 within about 24 seconds after leaving the calender 30, or within about 12 seconds, or within about 3 seconds, or within about 1 second.

Thereafter, the film-nonwoven laminate 90 is passed through a corona treatment station 36 and then through a printing station 38 to form a printed film-nonwoven laminate 20. Suitably, the film-nonwoven laminate 90 may be corona treated and/or printed before the thermoplastic polymer fibers 22 reach 75% of a final percent crystallization or before the fibers 22 reach 50% of a final percent crystallization.

If expressed in another way, the film-nonwoven laminate 90 passes through the corona treatment station 36 and/or printing station 38 within about 24 seconds after leaving the pressure roll arrangement 60, or within about 12 seconds, or within about 3 seconds, or within about 1 second.

Suitably, a print may be applied to a surface on a nonwoven side of the film-nonwoven laminate 90 using a digital printing process, a flexographic printing process or a combination digital-flexographic printing process. Alternatively or additionally, a print may be applied to a surface of a film side of the film-nonwoven laminate 90 using a digital printing process, a flexographic printing process or a combination digital-flexographic printing process.

Although FIG. 6 depicts laminating a fresh nonwoven web 26 to a pre-formed film 62, it should be understood that film 62 may be formed simultaneously with nonwoven web 26 as shown in FIG. 4.

Suitably, the printed film-nonwoven laminate 20 as shown in any of one the Figures may be formed at a line speed of about 200 fpm (about 60 m/min) to about 2000 fpm (about 610 m/min) or about 500 fpm (about 152 m/min) to about 2000 fpm (about 610 m/min) or about 1000 fpm (about 305 m/min) to about 2000 fpm (about 610 m/min).

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. An integrated method of forming a printed film-nonwoven laminate, comprising the steps of:
extruding a plurality of nonwoven fibers of thermoplastic polymer from a spinnerette, and forming a nonwoven web from the fibers;
corona treating the nonwoven web before the thermoplastic polymer reaches 75% of a final percent crystallization;
applying a print to a surface of the nonwoven web before the thermoplastic polymer reaches 75% of the final percent crystallization; and
combining the nonwoven web with a film.

2. The method of claim 1, wherein the nonwoven web is corona treated before the thermoplastic polymer reaches 50% of a final percentage of crystallization.

3. The method of claim 2, wherein the print is applied to the surface of the nonwoven web before the thermoplastic polymer reaches 50% of the final crystallization.

4. The method of claim 1, wherein the nonwoven web is a spunbond web.

5. The method of claim 1, wherein the print is applied to the surface of the nonwoven web using a digital printing process.

6. The method of claim 1, wherein the print is applied to the surface of the nonwoven web using a flexographic printing process.

7. The method of claim 1, wherein the print is applied to the surface of the nonwoven web using a combined flexographic-digital printing process.

8. The method of claim 1, further comprising the step of applying a print to a surface of the film.

9. The method of claim 1, further comprising forming the film while forming the nonwoven web.

10. An integrated method of forming a printed film-nonwoven laminate, comprising the steps of:
extruding a plurality of thermoplastic polymer fibers and forming a nonwoven web;
laminating the nonwoven web to a film to form a film-nonwoven laminate before the thermoplastic polymer fibers reach 75% of a final percent crystallization;
corona treating the film-nonwoven laminate before the thermoplastic fibers of the nonwoven web reach 75% of a final percent crystallization; and
applying a print to a surface of the film-nonwoven laminate before the thermoplastic fibers of the nonwoven web reach 75% of the final crystallization.

11. The method of claim 10, wherein the printed film-nonwoven laminate is formed at a line speed of about 500 fpm to about 2000 fpm.

12. The method of claim 10, wherein the print is applied to a surface of a nonwoven side of the film-nonwoven laminate.

13. The method of claim 10, wherein the print is applied to a surface of a film side of the film-nonwoven laminate.

14. The method of claim 10, further comprising forming the film simultaneously with the nonwoven web.

15. A continuous, integrated method of forming a printed film-nonwoven laminate, comprising the steps of:
forming a spunbond web of polypropylene fibers;
applying a print to a surface of the spunbond web before the polypropylene fibers reach 75% of a final crystallization;
forming a film simultaneously with forming the spunbond web; and
laminating the film to the spunbond web before the polypropylene fibers reach 75% of a final crystallization.

16. The method of claim 15, further comprising the step of corona treating the spunbond web before the polypropylene fibers reach 75% of a final crystallization;

17. The method of claim 15, further comprises the step of stretching the film to render it breathable.

18. The method of claim 15, wherein the step of applying the print to a surface of the spunbond web comprises:
applying a base print; and
applying at least one detail print over the base print.

19. The method of claim 18, wherein the base print is applied to a surface of the spunbond web using a flexographic printing process.

20. The method of claim 18, wherein the at least one detail print is applied over the base print using a digital printing process.
